(19) United States
(12) Patent Application Publication
(10) Pub. No.: US 2021/0207500 A1
(43) Pub. Date: Jul. 8, 2021

(54) EXHAUST-GAS TREATMENT DEVICE, AIRCRAFT PROPULSION SYSTEM, AND METHOD FOR TREATING AN EXHAUST-GAS STREAM

(71) Applicant: MTU Aero Engines AG, Muenchen (DE)

(72) Inventors: Hermann KLINGELS, Dachau (DE); Oliver SCHMITZ, Muenchen (DE)

(21) Appl. No.: 17/056,085

(22) PCT Filed: May 21, 2019
(86) PCT No.: PCT/DE2019/000142

§ 371 Date: Jan. 15, 2021

(30) Foreign Application Priority Data
May 22, 2018 (DE) 10 2018 208 026.7

(51) Int. Cl. F01K 25/14; F02C 6/18; B64D 33/04

(52) U.S. Cl. CPC F01K 25/14; F05D 2220/323; B64D 33/04; F02C 6/18

(57) ABSTRACT

An exhaust gas treatment device, an aircraft propulsion system and method for treating an exhaust gas stream are provided. The exhaust gas treatment has a condenser, which condenses at least a portion of water contained in the exhaust gas stream from the turbomachine and thereby releases a first energy; an evaporator, which evaporates at least a portion of the water condensed in the condenser and thereby absorbs a second energy, which is extracted from the exhaust gas stream from the turbomachine; a turbine, which is driven by steam output by the evaporator and expands the steam; a fan, which can be driven by the turbine and feeds the condenser ambient air in order that it absorb the first energy; and at least one exhaust apparatus, out of which the ambient air given off by the condenser and/or a dehumidified exhaust gas stream is exhausted from the condenser.

The present invention relates to an exhaust gas treatment device, an aircraft propulsion system having such an exhaust gas treatment device, and to a method for treating an exhaust gas stream. The exhaust gas treatment device utilizes an exhaust gas energy and reduces contrails produced by a condensation following an expansion.

### BACKGROUND

Airplanes (or generally aircraft) are usually propelled by heat engines in combination with suitable propulsion generators (propulsors). As propulsion generators, propellers and fans (“fans”) are used; moreover, the exhaust gas jet from the heat engine also contributes to the propulsion. The most commonly used heat engines are piston engines and gas turbines, the piston machines only being used today for relatively small aircraft.

At the present time, fossil fuels are almost exclusively used as sources of energy. Attempts have also been made with liquid hydrogen or liquid natural gas. Combusting these fuels results in undesirable environmental impacts that contribute to climate change. Combusting fossil fuels mainly produces carbon dioxide (CO₂) and water (H₂O); however, nitrogen oxides (NOₓ), sulfur oxides (SOₓ), unburned hydrocarbons (CₓH_{y}), carbon monoxide (CO) etc., can also be found in the exhaust gas. When hydrogen is used, mainly water and, due to the high process temperatures, also nitrogen oxides (NOₓ) are produced.

Under certain conditions, the water present in the exhaust gas produces contrails. They are formed when the warm, moist exhaust gas mixes with colder ambient air. Microscopically small water droplets or—if the ambient temperature is low enough—tiny ice crystals form on condensation nuclei (for example, dust/soot particles or electrically charged molecules).

There are contentious discussions among experts about the effect contrails and the resulting cirrus clouds have on global climate change, the view often being that the effect of contrails is of similar—if not even greater—importance than the CO₂ emissions. Thus, contrails contribute substantially to the climate impact of all air traffic.

U.S. Pat. No. 7,971,438 B2 describes an aircraft propulsion system where contrails are formed by the water vapor present in the exhaust gas condensing out before it is discharged into the atmosphere. The suggested system is composed of a gas turbine having a system of heat exchangers (recuperators). A first heat exchanger is disposed downstream of the last turbine stage. It transfers exhaust gas energy to the air delivered by the compressor before it enters into the combustion chamber, whereby the exhaust gas cools.

Subsequently thereto, it flows through a further heat exchanger (likewise a recuperator which serves as a condenser) where it is cooled further, for as long as energy is transferred to a cooler fluid, for example, air from a bypass stream (“bypass”), until the water vapor present in the exhaust gas—at least partially—condenses out. The resulting water is to be injected into the combustion chamber or simply discharged overboard in liquid form.

The cooled (dry) exhaust gas is then passed through a third heat exchanger. It is used for intercooling during the compression (“intercooler”). During the process, it is reheated and then mixed with the bypass air stream—whose flow has previously traversed the condenser—and is expanded in a common nozzle.

The recuperators are pure gas/gas heat exchangers. Since they operate at low pressure and also at small temperature differences, they are very voluminous and, therefore, heavy and, moreover, cause substantial pressure losses. The condenser, in particular operates on both flow sides at low pressure and at a small temperature difference, and, in addition, is to be located in the bypass flow—where the flow velocity is very high.

Theoretically, such a concept can, in fact, reduce contrails and enhance thermal efficiency in comparison to a conventional engine. However, the theoretical potential for improvement is likely to be exceeded by the aerodynamic losses caused by the heat exchangers (especially the condenser), the additional weight and the greater resistance to be expected because of the voluminous drive system.

U.S. Pat. No. 3,978,661 B1 describes a heat engine where a gas turbine process and a steam process are used in parallel. Disposed downstream of the last turbine is an evaporator through which the exhaust gas flows. The steam generated is introduced into the combustion chamber of the heat engine, resulting in a high specific enthalpy at the combustion chamber outlet. The exhaust gas is subsequently passed through a condenser where it is cooled to the point where the water contained therein—at least partially—condenses out.

British Patent Application GB 2 531 632 A describes a mechanical device having a spinning vessel which can be attached externally to an exhaust port of an aircraft gas turbine engine to suppress contrail formation. The exhaust gases are introduced into the device and come into contact with turbine blades, whereby the vessel and, therefore, the gases rotate in order to centrifugally separate moisture from the gases. Residual heat in the dewatered flow is partially recovered by the demand for thermal energy before the water is disposed of.

### SUMMARY OF THE INVENTION

It is an object of the specific embodiments of the present invention to provide an exhaust gas treatment device, an aircraft propulsion system and a method for treating an exhaust gas stream, which will make it possible in each case to achieve a higher thermal efficiency through efficient use of the exhaust gas energy and minimize the formation of contrails.

The present invention provides an exhaust gas treatment device, an aircraft propulsion system, and a method for treating an exhaust gas.

In accordance with a first aspect of the present invention, an exhaust gas treatment device for treating an exhaust gas stream from a turbomachine has a condenser, which condenses at least a portion of water contained in the exhaust gas stream from the turbomachine and thereby releases a first energy; an evaporator, which evaporates at least a portion of the water condensed in the condenser and thereby absorbs a second energy which is extracted from the exhaust gas stream from the turbomachine; a turbine, which is driven by steam output by the evaporator and which expands the steam; a fan which feeds the condenser ambient air in order that it absorb the first energy; and at least one exhaust apparatus, which exhausts the ambient air given off by the condenser and/or a dehumidified exhaust gas stream from the condenser. A corresponding method for treating an exhaust gas stream from a turbomachine has steps for condensing at least a portion of water contained in the exhaust gas stream from the turbomachine in a condenser, a first energy being released; for evaporating at least a portion of the water condensed in the condenser in an evaporator, a second energy being absorbed that is extracted from the exhaust gas stream from the turbomachine; for driving a turbine by steam output by the evaporator, and expanding the steam; for driving a fan to feed the condenser ambient air in order that it absorb the first energy; and for exhausting the ambient air given off by the condenser and/or a dehumidified exhaust gas stream from the condenser, out of at least one exhaust apparatus.

In comparison to the system, as described in U.S. Pat. No. 7,971,438 B2, only two heat exchangers in the form of the condenser and the evaporator are used in the present case that may likewise be built to have relatively small and compact dimensions because of the high specific power.

In accordance with an alternative, second aspect of the present invention, an exhaust gas treatment device for treating an exhaust gas stream from a turbomachine has a fan, which emits ambient air, a mixing device, which mixes the ambient air emitted by the fan with at least a portion of the exhaust gas stream from the turbomachine in order that at least a portion of water contained in the exhaust gas stream condenses; an evaporator, which evaporates at least a portion of the water condensed in the mixing device and thereby absorbs energy which is extracted from the exhaust gas stream from the turbomachine; a turbine, which is driven by steam output by the evaporator and which expands the steam, and an exhaust apparatus, out of which at least a portion of the exhaust gas stream that is mixed with the ambient air and dehumidified by the mixing device. A corresponding method for treating an exhaust gas stream from a turbomachine has steps for emitting ambient air by a fan; for mixing the ambient air emitted by the fan with at least a portion of the exhaust gas stream from the turbomachine by a mixing device, so that at least a portion of water contained in the exhaust gas stream condenses; for evaporating at least a portion of the water condensed in the mixing device in an evaporator in order that it absorb energy extracted from the exhaust gas stream from the turbomachine; for driving a turbine by steam output by the evaporator, expanding the steam; and for exhausting at least a portion of the exhaust gas stream that is mixed with the ambient air and dehumidified from the mixing device out of an exhaust apparatus.

In the second aspect of the present invention, a cooling device, which cools at least a portion of the exhaust gas stream from the turbomachine and thereby releases energy, is preferably disposed in the exhaust gas stream upstream of the mixing device.

In the second aspect, the size may be advantageously further reduced since the need for a separate condenser is eliminated.

In both aspects of the present invention, preferably disposed in the exhaust gas stream downstream of the condenser or downstream of the mixing device is a separating device, which separates the condensed water output by the condenser or by the mixing device and feeds it to the evaporator. It is also preferred that the separating device have a spray electrode, a precipitation electrode and/or a swirl generator, whereby the water separation may be optimized. Advantageously, the entire exhaust gas energy may still be present in the nozzles during expansion, and the separating device may have a low volumetric flow rate so that it has relatively small dimensions and effectively performs the water separation.

In both aspects, the water present in the exhaust gas of the heat engine is—at least largely—condensed. The thereby precipitated water is recovered and used for a semi-open cycle.

The fan may be driven by the turbine or by an auxiliary turbine, which, in turn, is driven by an exhaust gas stream from the evaporator.

In both aspects of the present invention, the steam expanded in the turbine is preferably introduced into a combustion chamber of the turbomachine and/or used for cooling components in a hot section of the turbomachine, thereby contributing to increasing the thermal efficiency.

Both aspects of the present invention provide that a condensate pump, a water treatment device, a water tank and/or a feed water pump be preferably disposed in the exhaust gas stream downstream of the condenser or downstream of the mixing device and upstream of the evaporator, making it possible to improve the supply of the separated water to the evaporator. It is also preferred that the condensate pump, the water treatment device, the water tank and/or the feed water pump be disposed downstream of a separating device.

The fan may be driven by the turbine or by an auxiliary turbine, which, in turn, is driven by the exhaust gas stream from the evaporator.

In an embodiment, one or a plurality of, especially all steps of the method may be performed in a fully or partially automated fashion, especially by a control or, alternatively, by a means/by means thereof.

### BRIEF DESCRIPTION OF THE DRAWINGS

Other advantageous embodiments of the present invention will become apparent from the dependent claims and the following description of preferred embodiments. To this end, the drawing shows, partly in schematic form, in:

FIG. 1 an aircraft propulsion system in accordance with a first specific embodiment of the present invention;

FIG. 2 an aircraft propulsion system in accordance with a second specific embodiment of the present invention;

FIG. 3 an aircraft propulsion system in accordance with a third specific embodiment of the present invention; and

FIG. 4 an aircraft propulsion system in accordance with a fourth specific embodiment of the present invention.

### DETAILED DESCRIPTION

The following describes the method of functioning on the basis of the example of a turbofan engine having a downstream evaporator and water recovery device.

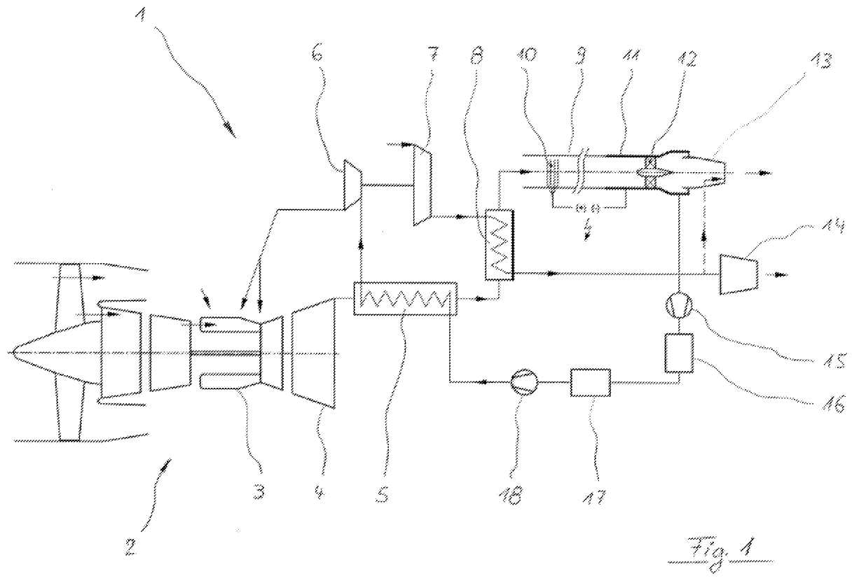

FIG. 1 schematically illustrates a specific embodiment of an aircraft propulsion system 1 according to the present invention. Aircraft propulsion system 1 has a turbomachine 2 in the form of a heat engine and an exhaust gas treatment device described below. Turbomachine 2 has a combustion chamber 3 and a low-pressure turbine 4.

The exhaust gases of heat engine 2 are not discharged in the customary manner, directly into the atmosphere where they mix with the ambient air and then form contrails, but are passed through an evaporator 5 disposed downstream of low-pressure turbine 4. There, energy for generating water vapor is extracted from the exhaust gas, whereby the exhaust gas temperature falls.

The water fed to evaporator 5 is first brought by a feed water pump 18 to a pressure which is appreciably higher than that in combustion chamber 3 of turbomachine 2.

At least one turbine 6 in the form of a steam turbine expands the high pressure steam generated in evaporator 5 to a pressure level barely over that of combustion chamber 3.

The steam may then be introduced directly into combustion chamber 3 and/or used for cooling components in the hot section. In comparison to an engine without a steam component as working fluid, the specific enthalpy at the outlet of combustion chamber 3 is greater because of the high specific heat capacity of the water.

The steam introduced into combustion chamber 3 increases the mass flow rate and thus the power output of aircraft propulsion system 1. The additional mass flow rate does not require any volumetric work. The pressure build-up in feed water pump 18 may take place in the liquid state. The specific useful power output thereby increases considerably and—in comparison to a conventional engine—the required power output is achieved by a significantly lower mass flow rate.

Turbine 6, in turn, drives a fan 7. Fan 7 delivers cold ambient air through a condenser 8, which, in the first specific embodiment, is disposed in the exhaust gas stream downstream of evaporator 5. The delivered ambient air absorbs energy from the exhaust gas stream. The heated ambient air is subsequently expanded in a nozzle 14 or alternatively added to the exhaust gas upstream of core engine nozzle 13. Alternatively, fan 7 may also be driven indirectly (for example, by an electric motor). In this case, steam turbine 6 may drive a generator or feed the power output thereof into turbomachine 2.

To obtain the water present in the exhaust gas stream in liquid form, it must be cooled below what is commonly known as the dew point thereof. This occurs in condenser 8. At the dew point, the relative humidity rises to 100%, so that saturation is reached. In response to a further cooling, the saturation vapor pressure decreases much more rapidly than the water partial pressure, resulting in supersaturation, and small water droplets form on condensation nuclei. After falling below the dew point temperature, the contained water is—at least partially—in liquid form.

The gas/water mixture is then passed into a separating device 9 in the form of a separating channel and subsequently expanded in core engine nozzle 13.

In separating channel 9, the water molecules are electrostatically charged, for example, by a spray electrode 10 in accordance with the corona charging method (impact ionization). At the surface of separating channel 9, the complementary pole is applied to a precipitation electrode 11. The electrostatic forces induce a movement of the water droplets towards a wall of separating channel 9 where the water is collected further downstream. Here, to support the separation effect, the inertia and the density difference between the water droplets and the gas mixture may be additionally utilized (for example, by a cyclone, a swirl generator, an abrupt deflection, etc.). A swirl generator 12 is illustrated exemplarily in FIG. 1. In principle, other separation methods known from water separation process engineering may be used.

The separated water is drawn off by a condensate pump 15, then passed via a water treatment device 16 into a water tank 17. The residual, purified exhaust gas stream without the separated water may be exhausted from core engine nozzle 13.

In the first specific embodiment, the water contained in the exhaust gas stream from heat engine 2 passes through evaporator 5, condenser 8, separating device 9, condensate pump 15, water treatment device 16, water tank 17, feed water pump 18, evaporator 5, turbine 6, in that order, and, if indicated, combustion chamber 3 or the components in the hot section. Already downstream of separating device 9, the purified exhaust gas from the exhaust gas stream from heat engine 2 leaves the circuit and is exhausted, for example, out of core engine nozzle 13.

In the first specific embodiment, the ambient air flows through fan 7, condenser 8 and nozzle 14, in that order, or is at least partially mixed with the purified exhaust gas and exhausted out of core engine nozzle 13.

An advantage of this system resides in that the entire exhaust gas energy is still present in the nozzles during the expansion, and separating device 9 has a low volumetric flow rate, thus relatively small dimensions, and the water separation is able to be effectively performed. In comparison to the system described in U.S. Pat. No. 7,971,438 B2, only two heat exchangers 5, 8 are used in the present case, which additionally, due to the high specific power, may be relatively small and compact in construction.

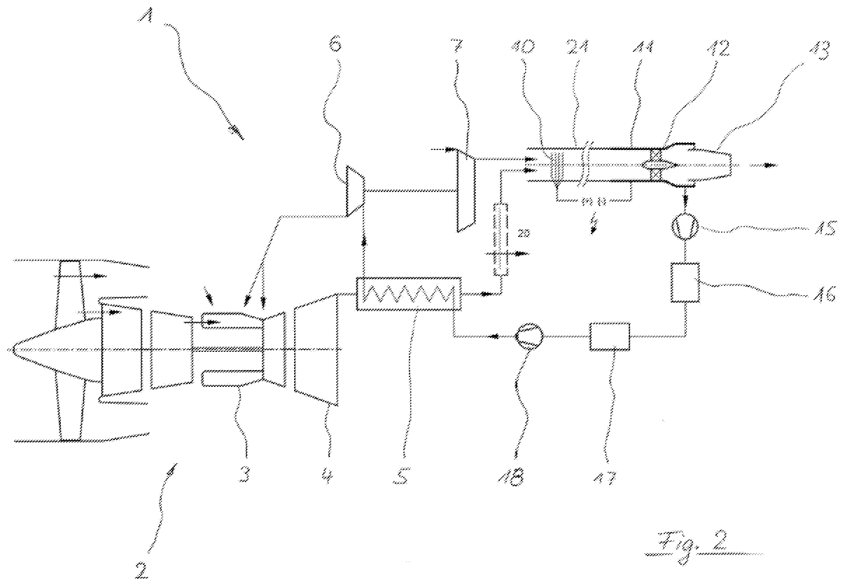

FIG. 2 schematically shows an alternative specific embodiment of the present invention. The reference numerals are substantially identical to those in FIG. 1.

In the second specific embodiment, a cooling device 20 in the form of a connecting channel is disposed in the exhaust gas stream downstream of evaporator 5. Cooling device 20 cools at least a portion of the exhaust gas stream from turbomachine 2 and thereby releases energy.

The main difference from the first specific embodiment is that, in the second specific embodiment, no condenser 8 is used, and the cold ambient air delivered by fan 7 is mixed with the already cooled exhaust gas in a mixing device 21 in the form of a mixing channel. In the second specific embodiment, mixing device 21 is disposed in the exhaust gas stream downstream of evaporator 5.

In the second specific embodiment, the water contained in the exhaust gas stream from heat engine 2 passes through evaporator 5, cooling device 20, mixing device 21, condensate pump 15, water treatment device 16, water tank 17, feed water pump 18, evaporator 5, turbine 6, in that order, and, if indicated, combustion chamber 3 or the components in the hot section. Already downstream of mixing device 21, the purified exhaust gas leaves the circuit and is exhausted, for example, from core engine nozzle 13.

In the second specific embodiment, the ambient air flows through fan 7 and mixing device 21, in that order, and is then at least partially exhausted with the purified exhaust gas from core engine nozzle 13.

Fan 7 and mixing device 21 are preferably located at a distance from heat engine 2. Cooling device 20 between evaporator 5 and mixing device 21 may preferably be placed without insulation along a surface of an aircraft (for example, on the wing, fuselage, etc.), whereby the exhaust gas already dissipates heat to the surrounding environment prior to the mixing in mixing device 21. The exhaust gas thereby cools down and is subsequently passed into mixing device 21 where cold ambient air is added until the contained water condenses. The water separation and treatment take place as in the first specific embodiment.

In the second specific embodiment, condensation may take place without any heat exchanger (condenser) due to the decrease in temperature, the releasing of energy to the surrounding environment, and the mixing with cold ambient air. However, the heat dissipated to the surrounding environment by cooling device 20 represents a loss because the enthalpy of the exhaust gas is reduced before the expansion in core engine nozzle 13.

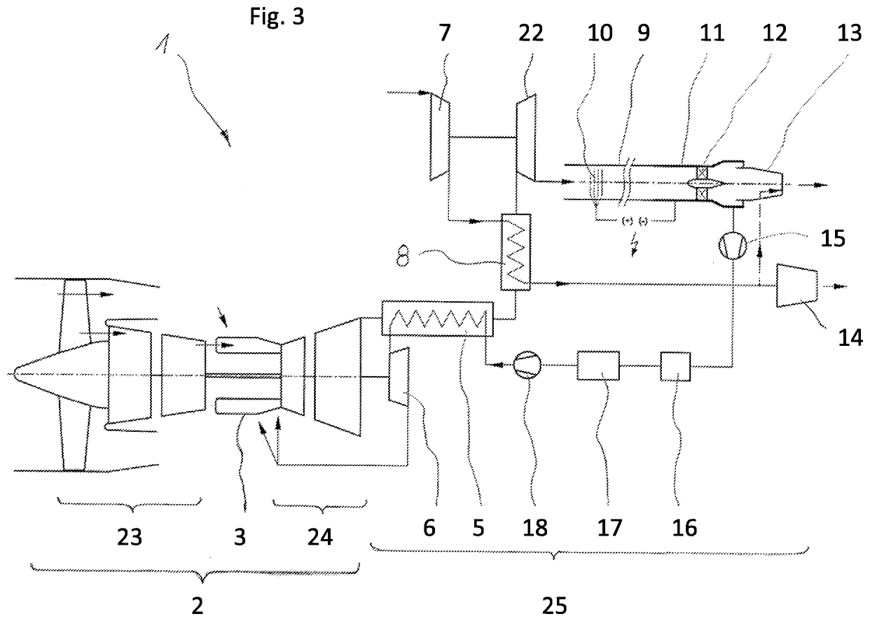

FIG. 3 shows an aircraft propulsion system in accordance with a third specific embodiment of the present invention. Those components, which are identical or similar to the components of the first specific embodiment, have the same reference numerals.

To use the exhaust gas energy, steam is likewise generated. Unlike a conventional engine where the exhaust gases of the heat engine are discharged directly into the atmosphere and mix there with the surrounding air and then form contrails, the third specific embodiment provides that a steam/water recovery system 25 be disposed downstream of heat engine 2.

Ambient air is delivered under pressure increase from a compressor section 23 of heat engine 2 into combustion chamber 3. There, the generated steam is added. Due to the high specific heat capacity of the water, a working gas having a very high specific enthalpy is produced by the combustion of fuel.

Some of the expansion takes place in a turbine section 24 of heat engine 2, the temperature of the exhaust gas at the outlet still being relatively high.

To obtain the water present in liquid form in the exhaust gas, it must be cooled below what is commonly known as the dew point. At the dew point, the relative humidity rises to 100%, and a saturation is thus reached. In response to further cooling, the saturation vapor pressure decreases much more rapidly than the water partial pressure, whereby a supersaturation occurs. Small water droplets form on condensation nuclei. After falling below the dew point temperature, the contained water is—at least partially—in liquid form.

An evaporator 5 is disposed downstream of turbine section 24 of heat engine 2. There, energy for generating water vapor is extracted from the exhaust gas, whereby the temperature thereof falls further. The exhaust gas is subsequently passed through (further) heat exchanger 8 and, from there, into an auxiliary turbine 22. Following expansion in auxiliary turbine 22, the exhaust gas temperature is lower than the dew point temperature, and the contained water is—at least partially—in liquid form.

Auxiliary turbine 22 drives fan 7. Fan 7 delivers cold ambient air through heat exchanger 8. Exhaust gas energy is transferred to the air which is delivered by fan 7, heats up and is then expanded in a nozzle 14 or, alternatively, added to the exhaust gas upstream of core engine nozzle 13. Alternatively, fan 7 may also be driven indirectly (for example, by an electric motor). In this case, auxiliary turbine 22 would drive a generator or feed the power output thereof into turbomachine 2.

Downstream of auxiliary turbine 22, the exhaust gas is passed into separating device (separating channel) 9 and subsequently expanded in core engine nozzle 13. In separating device 9, the water molecules are electrostatically charged in accordance with the corona charging method (impact ionization), for example, by spray electrode 10. The complementary pole is applied to precipitation electrode 11 at the surface or rather at a channel wall of separating device 9. The electrostatic forces induce a movement of the water droplets towards the channel wall where the water is collected further downstream. Here, to support the separation effect, the inertia and the density difference between the water droplets and the gas mixture may be additionally utilized (for example, by the use of a cyclone, a swirl generator, an abrupt deflection). A swirl generator 12 is illustrated exemplarily in FIG. 3. In principle, all separation methods known from water separation process engineering may be used.

The separated water is drawn off by condensate pump 15, then passed via water treatment device 16 into water tank 17.

Feed water pump 18 brings water vapor to a pressure that is at least somewhat higher than the pressure in combustion chamber 3 of heat engine 2. The steam generated may then be introduced directly into combustion chamber 3 of heat engine 2 or/and used for cooling components in the hot section. The steam may then be advantageously brought to a significantly higher pressure. Here, the turbine (steam turbine 6) expands the generated high pressure steam to a pressure level that is marginally higher than that of combustion chamber 3. As illustrated, the power output of turbine 6 may be fed directly to a shaft of heat engine 2 or used for driving auxiliaries. The power efficiency of heat engine 2 may thereby be further enhanced.

In the third specific embodiment, the water contained in the exhaust gas stream from heat engine 2 passes through evaporator 5, condenser 8, auxiliary turbine 22, separating device 9, condensate pump 15, water treatment device 16, water tank 17, feed water pump 18, evaporator 5, turbine 6, in that order, and, if indicated, combustion chamber 3 or the components in the hot section. Already downstream of separating device 9, the purified exhaust gas from the exhaust gas stream from heat engine 2 leaves the circuit and is exhausted, for example, out of core engine nozzle 13.

In the third specific embodiment, the ambient air flows through fan 7, condenser 8, and nozzle 14, in that order, or rather is at least partially mixed with the purified exhaust gas and exhausted out of core engine nozzle 13.

Overall, therefore, the propulsion system provided offers a number of advantages over a conventional engine or a conventional propulsion system:

The steam introduced into combustion chamber 3 increases the mass flow rate and thus the power output of turbine section 24. The additional mass flow rate does not require any volumetric work since the pressure build-up in feed water pump 18 takes place in the liquid state. The specific useful power output thereby increases considerably, and the required power output is achieved by a significantly lower mass flow rate. This makes it possible for all components (compressors, turbines, heat exchangers, such as evaporators and condensers, etc.) to be compact and thus lighter in construction.

The optimum overall pressure ratio is below that of a conventional engine. The number of compressor and turbine stages may be hereby reduced, which likewise has a positive effect on the weight and the size.

In comparison to the system, as described in U.S. Pat. No. 7,971,438 B2, only two heat exchangers are used in the present invention. On the exhaust gas side, evaporator 5 and condenser 8 are integrated in the expansion section, i.e., between turbines 24, 22. The advantage of this configuration is that both heat exchangers (evaporator 5 and condenser 8) operate at an increased pressure level on the hot side and, in the case of a greater temperature difference, between the heat exchange media. The heat transfer rates are thereby higher, and the specific volumetric flow rates become lower at comparable pressure losses. Together with the low mass flow rate mentioned above, relatively small, compact and, thus, light heat exchangers 5, 8 result.

The entire exhaust gas energy, including the condensation heat, is still present in the nozzles during expansion and thereby increases the outlet pulse.

Separating device 9 has a relatively low volumetric flow rate and thus relatively small dimensions. The water separation may be effectively implemented.

Climate-affecting emissions may be significantly reduced because a) the specific fuel consumption is decreased by the efficient use of the exhaust gas energy and the reduction in required power output during compression of the working medium and b) the formation of nitrogen oxides (NOx) is greatly reduced by the supply of heat in combustion chamber 3 in the presence of water.

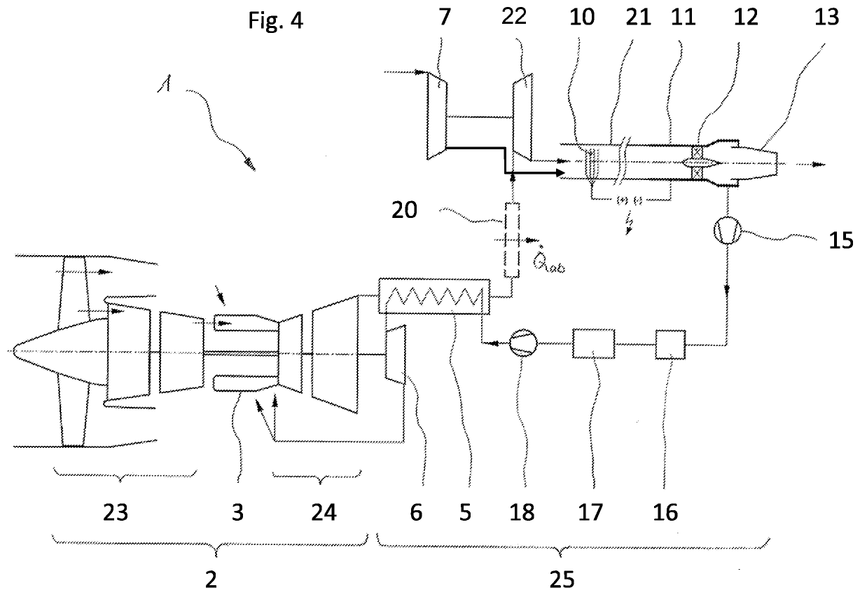

FIG. 4 shows an aircraft propulsion system in accordance with a fourth specific embodiment of the present invention. Those components, which are identical or similar to the components of the second specific embodiment, have the same reference numerals.

The main difference from the third specific embodiment is that, in the fourth specific embodiment, no condenser 8 is used, and the cold ambient air delivered by fan 7 is mixed with the already cooled down exhaust gas in mixing device (mixing channel) 21.

Behind evaporator 5, the exhaust gas is passed via a cooling device (connecting channel) 20 to auxiliary turbine 22 and expanded there. Cooling device 20 may advantageously be located at a distance from heat engine 2. Cooling device 20 between evaporator 5 and auxiliary turbine 22 may preferably be placed along the surface of the aircraft (for example, on the wing, fuselage, etc.) and also preferably without insulation, whereby the exhaust gas cools already before expansion in auxiliary turbine 22 by dissipating heat to the surrounding environment. The exhaust gas is subsequently passed into mixing device 21 where so much cold ambient air is added by fan 7 that the contained water condenses. The water separation and treatment are carried out as in the third specific embodiment of FIG. 3.

The condensation may take place without any heat exchanger (condenser 8) due to the decrease in temperature, the releasing of energy to the surrounding environment and the mixing with cold ambient air. However, the heat dissipated to the surrounding environment by cooling device 20 represents a loss because the enthalpy of the exhaust gas is reduced before the expansion in core engine nozzle 13.

As in the third specific embodiment and as illustrated, the power output of turbine 6 may be fed directly to a shaft of heat engine 2 or used for driving auxiliaries. The power efficiency of heat engine 2 may thereby be further enhanced.

In the fourth specific embodiment, the water contained in the exhaust gas stream from heat engine 2 passes through evaporator 5, cooling device 20, auxiliary turbine 22, mixing device 21, condensate pump 15, water treatment device 16, water tank 17, feed water pump 18, evaporator 5, turbine 6, in that order, and, if indicated, combustion chamber 3 or the components in the hot section. Already downstream of mixing device 21, the purified exhaust gas leaves the circuit and is exhausted, for example, out of core engine nozzle 13.

In the fourth specific embodiment, the ambient air flows through fan 7 and mixing device 21, in that order, and is then at least partially exhausted with the purified exhaust gas out of core engine nozzle 13.

Although exemplary embodiments were explained in the preceding description, it should be noted that many modifications are possible. It should also be appreciated that the exemplary embodiments are merely examples and are in no way intended to restrict the scope of protection, the uses or the design. Rather, the foregoing description provides one skilled in the art with a guideline for realizing at least one exemplary embodiment; various modifications being possible, particularly with regard to the function and placement of the described components, without departing from the scope of protection as derived from the claims and the combinations of features equivalent thereto.

### LIST OF REFERENCE NUMERALS

1 aircraft propulsion system
2 turbomachine (heat engine)
3 combustion chamber
4 low-pressure turbine
5 evaporator
6 turbine (steam turbine)
7 fan
8 condenser
9 separating device (separating channel)
10 spray electrode
11 precipitation electrode
12 swirl generator
13 core engine nozzle
14 nozzle
15 condensate pump
16 water treatment device
17 water tank
18 feed water pump
20 cooling device (connecting channel)
21 mixing device (mixing channel)
22 auxiliary turbine
23 compressor section
24 turbine section
25 exhaust gas treatment device, steam/water recovery system

1-13. (canceled)

14. An exhaust gas treatment device for treating an exhaust gas stream from a turbomachine, the exhaust gas treatment device comprising:
a condenser condensing at least a portion of water contained in the exhaust gas stream from the turbomachine to release a first energy;
an evaporator evaporating at least a portion of the water condensed in the condenser to absorb a second energy extracted from the exhaust gas stream from the turbomachine;
a turbine driven by steam output by the evaporator and expanding the steam;
a fan feeding the condenser ambient air to absorb the first energy; and
at least one exhaust apparatus, the ambient air emitted by the condenser or a dehumidified exhaust gas stream from the condenser being exhausted out of the exhaust apparatus.

15. An exhaust gas treatment device for treating an exhaust gas stream from a turbomachine, the exhaust gas treatment device comprising:
a fan emitting ambient air;
a mixer mixing the ambient air emitted by the fan with at least a portion of the exhaust gas stream from the turbomachine, so that at least a portion of water contained in the exhaust gas stream condenses;
an evaporator evaporating at least a portion of the water condensed in the mixer to absorb energy extracted from the exhaust gas stream from the turbomachine;
a turbine driven by steam output by the evaporator and expanding the steam; and
an exhaust apparatus, out of which at least a portion of the exhaust gas stream mixed with the ambient air and dehumidified from the mixer being exhausted out of the exhaust apparatus.

16. The exhaust gas treatment device as recited in claim 15 further comprising a cooling device in the exhaust gas stream upstream of the mixer and cooling at least a portion of the exhaust gas stream from the turbomachine to release energy.

17. The exhaust gas treatment device as recited in claim 15 wherein the fan is driven by the turbine or by an auxiliary turbine, the auxiliary turbine, in turn, being driven by an exhaust gas stream from the evaporator.

18. The exhaust gas treatment device as recited in claim 15 wherein disposed in the exhaust gas stream downstream of the mixer is a separator separating the condensed water output by the mixer and feeds the condensed water to the evaporator.

19. The exhaust gas treatment device as recited in claim 18 wherein the separator has a spray electrode, a precipitation electrode or a swirl generator.

20. The exhaust gas treatment device as recited in claim 15 wherein the steam expanded in the turbine is introduced into a combustion chamber of the turbomachine or is used for cooling components in a hot section of the turbomachine.

21. The exhaust gas treatment device as recited in claim 15 wherein disposed in the exhaust gas stream downstream of the mixer and upstream of the evaporator, are a condensate pump, a water treatment device, a water tank or a feed water pump.

22. An aircraft propulsion system comprising the exhaust gas treatment device as recited in claim 15 and the turbomachine.

23. A method for treating an exhaust gas stream from a turbomachine comprising the steps of:
condensing in a condenser at least a portion of water contained in the exhaust gas stream from the turbomachine, a first energy being released;
evaporating in an evaporator at least a portion of the water condensed in the condenser, a second energy being absorbed and being extracted from the exhaust gas stream from the turbomachine;
driving a turbine by steam output by the evaporator, and expanding the steam;
driving a fan to feed the condenser ambient air to absorb the first energy; and
exhausting out of at least one exhaust apparatus the ambient air emitted by the condenser or a dehumidified exhaust gas stream.

24. A method for treating an exhaust gas stream from a turbomachine comprising the steps of:
emitting ambient air by a fan;
mixing the ambient air emitted by the fan with at least a portion of the exhaust gas stream from the turbomachine by a mixer, so that at least a portion of water contained in the exhaust gas stream condenses;
evaporating at least a portion of the water condensed in the mixer by an evaporator to absorb energy extracted from the exhaust gas stream from the turbomachine;
driving a turbine by steam output by the evaporator and expanding the steam; and
exhausting at least a portion of the exhaust gas stream mixed with the ambient air and dehumidified from the mixing device out of at least one exhaust apparatus.

25. The method as recited in claim 24 further comprising introducing the steam expanded in the turbine into a combustion chamber of the turbomachine or using the steam expanded in the turbine for cooling components in a hot section of the turbomachine.

26. The method as recited in claim 24 wherein the fan is driven by the turbine or by an auxiliary turbine, the auxiliary turbine, in turn, being driven by the exhaust gas stream from the evaporator.

27. The method as recited in claim 23 further comprising introducing the steam expanded in the turbine into a combustion chamber of the turbomachine or using the steam expanded in the turbine for cooling components in a hot section of the turbomachine.

28. The method as recited in claim 23 wherein the fan is driven by the turbine or by an auxiliary turbine, the auxiliary turbine, in turn, being driven by the exhaust gas stream from the evaporator.

29. The exhaust gas treatment device as recited in claim 14 wherein the fan is driven by the turbine or by an auxiliary turbine, the auxiliary turbine, in turn, being driven by an exhaust gas stream from the evaporator.

30. The exhaust gas treatment device as recited in claim 14 wherein disposed in the exhaust gas stream downstream of the condenser is a separator separating the condensed water output by the condenser and feeds the condensed water to the evaporator.

31. The exhaust gas treatment device as recited in claim 30 wherein the separator has a spray electrode, a precipitation electrode or a swirl generator.

32. The exhaust gas treatment device as recited in claim 14 wherein the steam expanded in the turbine is introduced into a combustion chamber of the turbomachine or is used for cooling components in a hot section of the turbomachine.

33. The exhaust gas treatment device as recited in claim 14 wherein disposed in the exhaust gas stream downstream of the condenser and upstream of the evaporator, are a condensate pump, a water treatment device, a water tank or a feed water pump.

34. An aircraft propulsion system comprising the exhaust gas treatment device as recited in claim 14 and the turbomachine.
